(19) United States
(12) Patent Application Publication
(10) Pub. No.: US 2021/0076793 A1
(43) Pub. Date: Mar. 18, 2021

(54) EXTERNAL FRAME LUGGAGE WITH FOLD-OUT COMPUTER CASE

(71) Applicant: 12 Gauge Ideas LLC, Pinehurst, NC (US)

(72) Inventors: Kelly Lynn McAlister, Altamonte Springs, FL (US); Alexander Otto Jacoby, Pinehurst, NC (US)

(73) Assignee: 12 Gauge Ideas LLC, Pinehurst, NC (US)

(21) Appl. No.: 17/107,285

(22) Filed: Nov. 30, 2020

Related U.S. Application Data
(63) Continuation-in-part of application No. 15/812,019, filed on Nov. 14, 2017, now abandoned.

(51) Int. Cl. A45C 13/04; A45C 13/26; A45C 13/36; A45C 13/38

(52) U.S. Cl. CPC A45C 13/04; A45C 13/262; A45C 2011/003; A45C 13/385; A45C 13/36

(57) ABSTRACT

An external frame for use with a piece of luggage having a fold-out computer case or detachable bag connection frame that has the ability to lay flat and can easily be removed with one hand in preparation for inspection through an X-Ray machine and other inspection machines.

This application is a continuation-in-part of U.S. non-provisional application Ser. No. 15/812,019 filed on Nov. 14, 2017, and which is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to luggage. In particular, it relates to a piece of luggage having an external frame and a fold-out computer case for use through an X-ray and other inspection machines.

### Description of Related Art

The use of luggage (often called trolley case or wheeled totes) in airline travel has become quite prevalent. Such luggage is normally rectangular in shape with four corners. In order to hold their shape, manufacturers of such luggage utilize internal or external frames. These frames must be substantial enough to deal with the heavy loads and strains put on the soft parts of the luggage. They must also protect the luggage from abuse such as being dropped or the heavy handling the luggage goes through during the loading and unloading processes with airline travel.

A number of different frame types have been developed. The internal frames tend to restrict the amount of space that's available to the user. The external frames free up internal room, however, they tend to be heavier than internal frames and as such, are not utilized very often. They all have trouble with other than straight line movement and are difficult to maneuver outside the straight line.

Another problem with luggage and travel is that newer requirements require laptops to be openly accessible for inspection as one enters the airport security area. They are required to lay flat in a case and not hidden inside the regular luggage. However, carrying them separately can be cumbersome or it may mean exceeding the number of luggage pieces permitted on board an airplane. Adversely, putting laptops inside the luggage means digging them out while in line at security and then stowing them back inside the luggage afterwards. There is a tremendous need for improved external frames for luggage, as well as an improved way of traveling with a laptop or other electronic device through security at an airport.

### BRIEF SUMMARY OF THE INVENTION

The present invention relates to the discovery of a new type of external frame which easily adapts to a soft, rectangular luggage piece (case) and that has a fold down or detachable bag connection frame allowing both a laptop case and the luggage to lay flat on a conveyor. In addition, the present invention allows for the laptop case to be easily removed with one hand as well as offering enough room for an additional accessory case, which also can be removed. In another embodiment, the luggage piece has wheels, slides, or rollers which roll perpendicular to the regular main wheels, wherein some or all of the wheels are removable for easy replacement or can aid in fitting into tight spaces.

Accordingly, in one embodiment, there is a luggage article comprising a case portion having a backside, front panel, top, bottom, and four corners, the luggage article further comprising:
a) a bag connection frame which connects either to the case backside or an external back panel which is connected to the case backside;
b) main wheels mounted on a wheel assembly;
c) a collapsible two-arm luggage handle and two-arm luggage handle frame;
d) one or more removable bags mounted in between the two-arm luggage handle frame of the bag connection frame; and
e) wherein the bag connection frame can be removed to lay flat, separate from the case portion.

### BRIEF DESCRIPTION OF THE DRAWINGS

FIG. 1 is an exploded view of the luggage of the present invention.

FIG. 2 is a top angled perspective view of the luggage of the present invention.

FIG. 3 is a perspective view of the external frame laid open on a security X-ray belt with both the case portion and laptop case laying flat on the conveyor belt of the present invention.

FIG. 4 is a perspective view of the perpendicular moving side wheels of the present invention.

FIG. 5 is a close-up view of the removable main wheels of the present invention.

FIG. 6 is a perspective view of a bag connection frame of the present invention.

FIG. 7 is a perspective view of an alternative embodiment and the bag connection frame of FIG. 6 of the present invention.

FIG. 8 is a perspective view of a bag connection frame with cases attached of the present invention.

FIG. 9 is a perspective view of a portion of the bag connection frame with the attachment panel of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “luggage” or “bags” refers to soft-sided or hard-sided trolley style luggage with a rigid form essentially rectangular in shape for holding clothes, or the like, as shown in the Figures. The luggage of the present invention's bag connection frame has wheels and a tote handle with two arms, wherein bags can be attached, especially as shown in the Figures. In some embodiments, the bag is a laptop case and an accessory case.

As used herein, the term “case portion” refers to the portion of the luggage holding clothes and other items, other than the bags attached to the pivotable frame as defined herein.

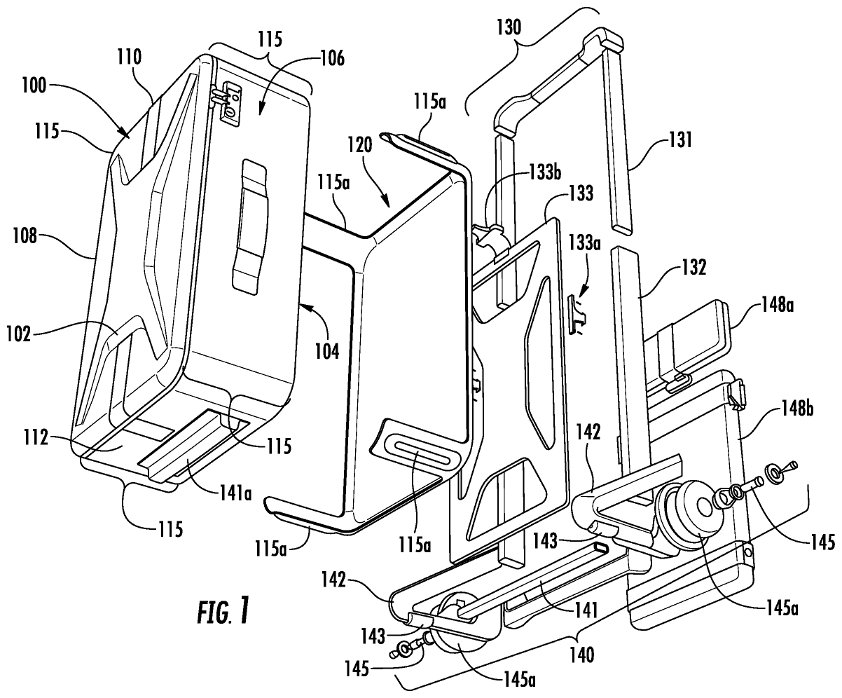

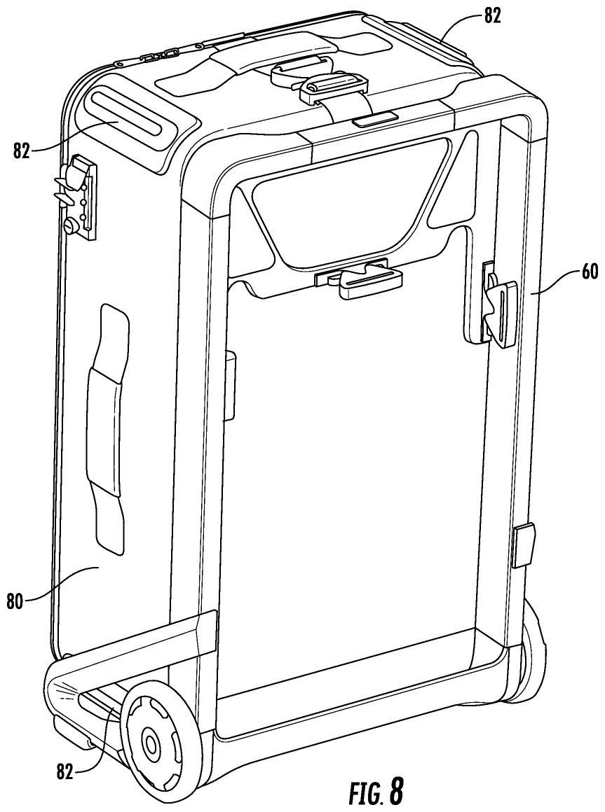

As used herein, the term “corners” refers to the four corners of the case portion of the luggage, as can be further seen in the Figures that follow. The corners may be integral to the case (e.g., FIG. 8) or added to the frame (e.g., FIG. 1).

As used herein, the term “rigid single-piece external back panel” refers to an optional single molded metal or plastic type panel which adds rigidity to the otherwise flexible case portion of the luggage. In one embodiment, the plastic is a polymer resin which is utilized to manufacture the panel. The panel can have four projections that cover the corners of the case and a substantially flat panel that covers the bottom of the case, as shown in the Figures. In one embodiment, the corner covers are separate from the back panel. In one embodiment, there is no back panel and the bag connection frame mounts to the case backside.

As used herein, the term “bag connection frame” refers to use of a generally rectangular external frame connected to the case portion of the luggage, wherein it is roughly the same length and width of the case portion. The frame pivots or is removable, as noted below, to allow the case portion and the bag connection frame to both lay flat on the same level flat surface like on the belt used with an X-ray machine in an airport. In one embodiment, it is made of aluminum or other rigid material. One or more bags can be attached to the bag attachment frame.

As used herein, the term “attachment panel” refers to a rigid panel made of plastic, metal, or the like which is part of the bag connection frame and can attach to the external back panel or to the case backside. In one embodiment, the attachment is by a clip or lock and the bag can be attached to this panel on either end of the case.

As used herein, the term “wheels on a wheel assembly” refers to the main wheels, which can be quick release wheels and attach to the bag connection frame and, in one embodiment, via a wheel axle. The wheel axle is then mounted to the bottom side of the case portion via a mount device. One version is shown in the Figures. Also attached to the wheel assembly are feet on each side, which are capable of aiding in standing the luggage up on its bottom. Perpendicularly mounted secondary wheels (e.g., barrel) or slides (perpendicular to the travel of the main wheels) aid the user of the luggage in turning the luggage in directions other than straight in the direction of travel of the main wheels.

As used herein, the term “collapsible two-arm luggage handle” refers to a collapsible two-arm luggage handle with a two-arm luggage handle frame built into the bag connection frame. Such devices are well known in the art and one example is shown in the Figures.

As used herein, the term “bag connection” refers to bags which will fit in between each of the upright arms of the frame. In one embodiment, one of the bags is a laptop bag which allows an individual to lay the case portion and laptop bag flat on the same surface at the same time because it is connected to the bag connection frame, as shown in the Figures. The size of the bag can be small or large, but generally is of a size that is positioned inside the bag connection frame and can extend between at least 2 paralleled sides of the bag connection frame.

### DRAWINGS

Now referring to the drawings, FIG. 1 is an exploded view of an embodiment of the present invention luggage. Case 100 includes a plurality of panels and is designed to enclose an internal volume for carrying articles of the user. The case can be soft or hard-sided. Front and back opposing panels 102 and 104, opposing side panels 106 and 108, and top and bottom panels 110 and 112 collectively form the rectangular case portion. The formation of the case creates four corners 115, each on top and bottom panels 110 and 112. In this embodiment, an optional external rigid single piece external back panel 120 substantially covers the back panel 104 and corners 115 with projections 115a as shown in subsequent Figures. The corner covers can be separate from the panel 120 and mounted directly on the bag corners.

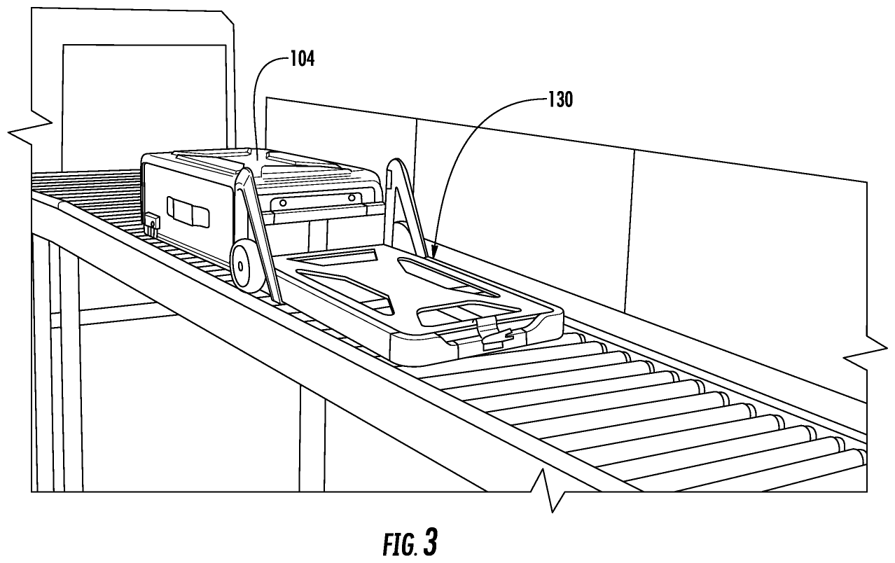

The rectangular bag connection frame 130 consists of several parts. The collapsible two-arm luggage handle 131 slides in and out of the two-arm luggage handle frame 132. The attachment panel 133 (part of the back connection frame) is attached between the two-arm upright rectangle connection panel arms 131 and 132 via clips 133a. The attachment panel 133 with locks on the back panel 120 utilizes locking clip 133b. A wheel frame assembly 140 is shown without wheels attached and consists of a handle or grab bar 141, feet 142, and secondary side sliders (or wheels) 143. The pivot frame pivots by placement of wheel axle 145 into pivot cylinder 145a, which allows the bag connection frame 130 to pivot or be removed and lay flat when the case 100 is laying flat, as shown in FIG. 3.

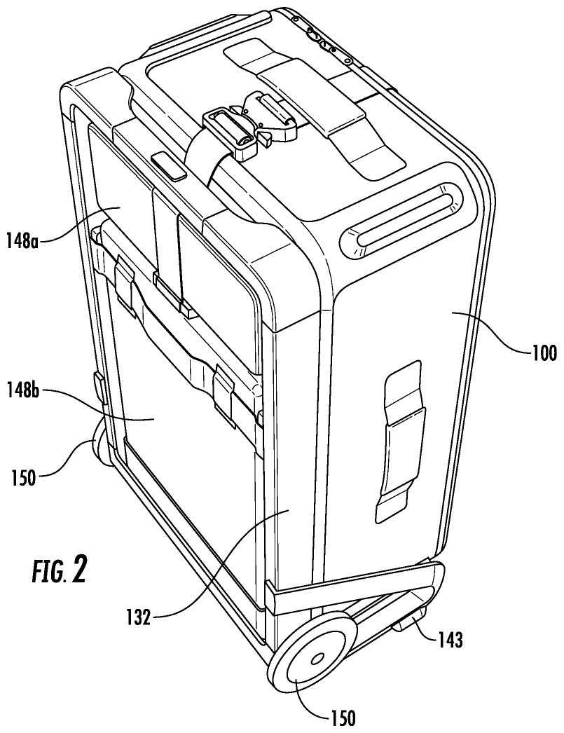

FIG. 2 is a perspective view of the entire piece of luggage shown in FIG. 1. In this view, it shows wheels 150 and side wheels or side sliders 143. In this view, two bags 148a and 148b are shown for mounting in between the arms of the luggage handle frame 132 while one or less small bags could be used. In this view, bag 148b is a laptop bag and the other bag 148a is a small carry bag.

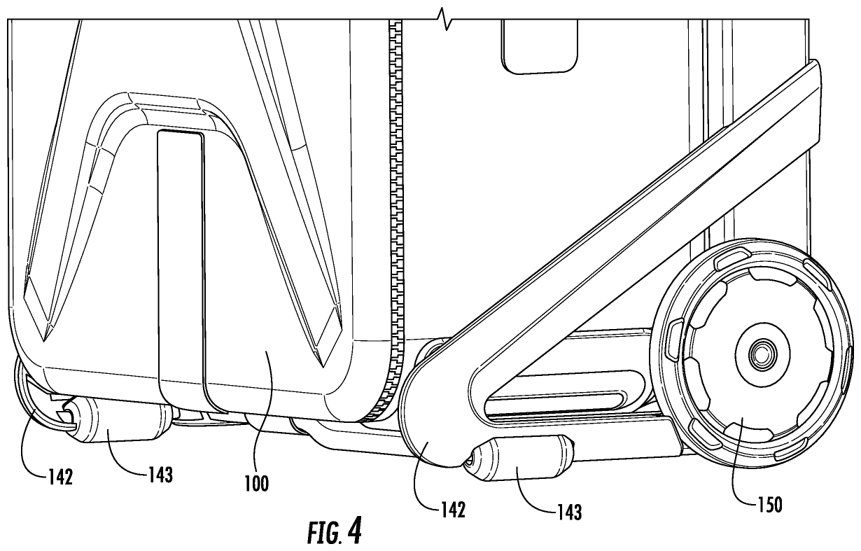

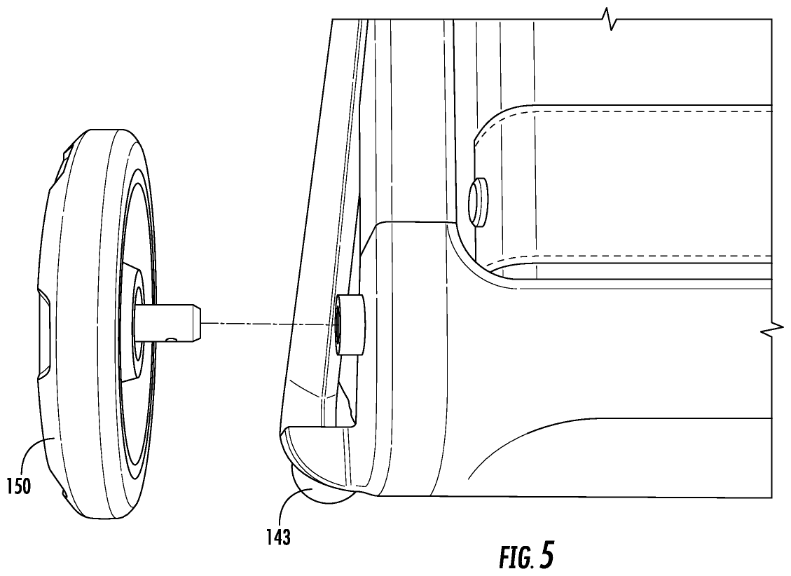

FIG. 3 shows the luggage of the present invention sitting on a conveyor roller. In this view, the bag connection frame 130 has been pivoted such that the case portion 104 and bag connection frame 130 are both lying flat on the roller. In this perspective view, the laptop can easily be viewed by security. In this view, the bag connection frame has been attached directly to case portion backside. FIG. 4 is a close up of the bottom of the luggage clearly showing the feet 142 and perpendicular operating wheels, slides, or rollers 143, as well as regular wheels 150. In this embodiment, the wheels 143 and 150 are all removable and replaceable with quick release or otherwise. FIG. 5 shows a quick release of regular wheel 150.

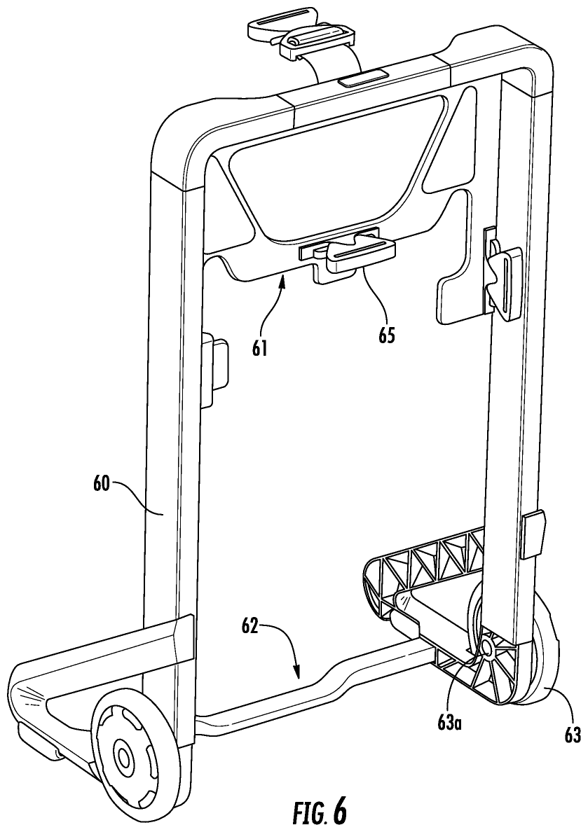

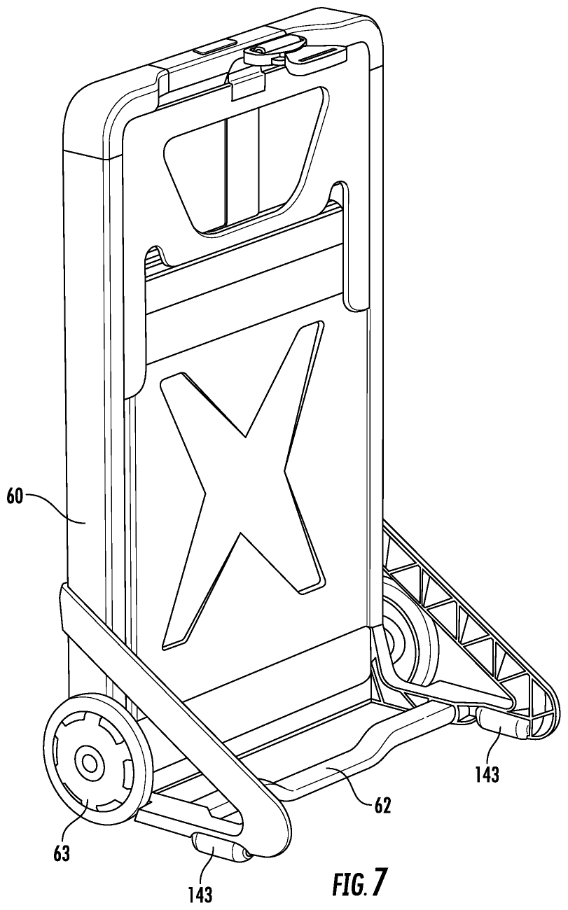

FIGS. 6, 7, and 8 show alternate embodiments of the present invention. FIG. 6 is a perspective view of a bag connection frame 60. In this view, a handle or grab bar 62 is clearly shown. Wheels 63 fit into race 63a. Locking clip 65 is shown on attachment panel 61 for connecting bags. FIG. 7 is a perspective view of the bag connection frame 60. Perpendicular operating wheels, slides, or rollers 143 are also shown. FIG. 8 is a perspective view of the bag connection frame 60 with an attached case 80. It is shown without the cases in FIG. 7. In this view, corner covers 82 cover the corners of the case portion of the luggage.

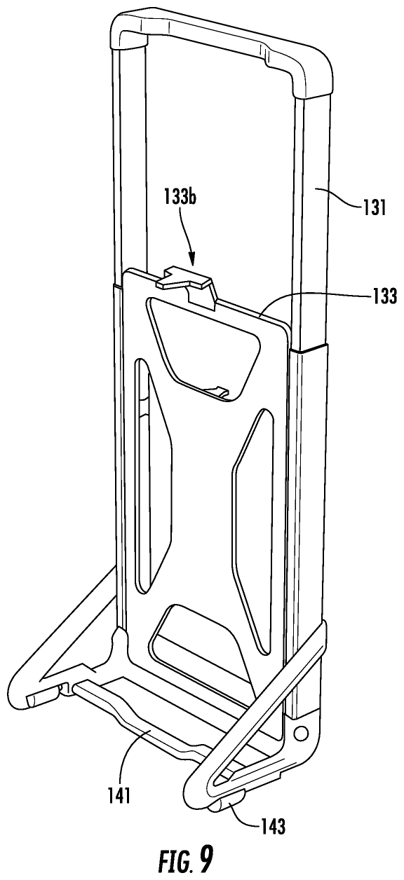

In FIG. 9, we see a version of the bag attachment frame without wheels (though with secondary wheels 143). In this view, we can clearly see the attachment panel 133, locking clip 133b, the collapsible two-arm luggage handle 131, and handle or grab bar 141.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A luggage article comprising a case portion having a backside, front panel, top, bottom, and four corners, the luggage article further comprising:
a) a bag connection frame which connects either to the case backside or an external back panel which is connected to the case backside;
b) main wheels mounted on a wheel assembly;
c) a collapsible two-arm luggage handle and two-arm luggage handle frame;
d) one or more removable bags mounted in between the two-arm luggage handle frame of the bag connection frame; and
e) wherein the bag connection frame can be removed to lay flat, separate from the case portion.

2. The luggage article according to claim 1 which further comprises secondary wheels or slides mounted on the bag connection frame designed to operate in a direction perpendicular to a direction of the main wheels mounted on the wheel assembly.

3. The luggage article according to claim 1 wherein the bag connection frame pivots by a wheel assembly axle mounted pivotally on a bottom side of the case portion.

4. The luggage article according to claim 1 wherein the bag connection frame can be disconnected from the case portion or back panel.

5. The luggage article according to claim 1 wherein the main wheels are quick release type wheels.

6. The luggage article according to claim 1 wherein one of the bags mounted in between the two-arm luggage handle frame is a laptop bag.

7. The luggage article according to claim 1 wherein the bag connection frame further comprises rigid feet for aiding in standing the luggage on a bottom.

8. The luggage article according to claim 1 wherein the case portion has a rigid single piece external back panel mounted on the case backside for attaching the bag connection frame.

9. The luggage article according to claim 1 wherein the bag connection frame can removably lock against the case portion or an external back panel.

10. The luggage article according to claim 9 wherein there is an attachment panel on the bag connection frame for attaching the case portion or back panel and which the bags can be removably attached.

11. The luggage article according to claim 1 wherein when the case front panel is laying on a flat surface, the connection panel can be positioned to lay flat on the same flat surface as the case front panel.

12. The luggage article according to claim 1 wherein there are rigid coverings on the 4 corners of the case.

13. The luggage article according to claim 1 wherein the connection panel comprises an attachment panel for attaching to the case portion or the back panel and attaching the bags.
